(19) United States
(12) Patent Application Publication
(10) Pub. No.: US 2004/0248679 A1
(43) Pub. Date: Dec. 9, 2004

(54) Torque limiting device for wheeled vehicle

(76) Inventors: Yu-Wen Hsu, Kaohsiung Hsien (TW); Yan-Min Su, Kaohsiung Hsien (TW); Kun-Che Lee, Kaohsiung Hsien (TW)

Correspondence Address: MARY LOU FLOYD, 380 MOUNTAIN RD, #1212, UNION CITY, NJ, 07087, US

(21) Appl. No.: 10/453,296

(22) Filed: Jun. 3, 2003

(51) Int. Cl. F16H 59/00; F16H 63/00

(52) U.S. Cl. 474/15

(57) ABSTRACT

A torque limiting device for a wheeled vehicle includes a fixed boss, a plurality of rolling balls, a roller retainer, a roller seat, several disk springs, and a driven housing. Thus, when the wheeled vehicle is suddenly braked under the emergency condition or when the rear tires are subjected to a larger resistance and excessive torque, the driven shaft disengages from the fixed boss, and the rotation of fixed boss cannot drive and rotate the driven shaft, such that the driven shaft stops rotating temporarily, thereby preventing the transmission parts of the CVT and reducing speed system of the wheeled vehicle from being broken or worn out by the excessive torque.

### BACKGROUND OF THE INVENTION

1. Field of the Invention

The present invention relates to a torque limiting device, and more particularly to a torque limiting device for a wheeled vehicle.

2. Description of the Related Art

A conventional CVT (continuously variable transmission) for a wheeled vehicle shown in FIGS. 1-4 comprises a drive shaft 1 for transmitting the power, a drive pulley 14 fixedly mounted on the drive shaft 1, a ramp plate 11 fixedly mounted on the drive shaft 1, a movable pulley 12 movably mounted on the drive shaft 1 and located between the drive pulley 14 and the ramp plate 11, a roller 13 rotatably mounted between the movable pulley 12 and the ramp plate 11, a driven shaft 3 driven by the drive shaft 1, a fixed boss 4 fixedly mounted on the driven shaft 3 for rotating the driven shaft 3 and provided with a protruding fixed pulley 41, a movable boss 5 movably mounted on the fixed boss 4 and provided with a protruding movable pulley 51, and a transmission belt 2 mounted between the drive pulley 14 and the movable pulley 12 and mounted between the fixed pulley 41 and the movable pulley 51. In addition, the driven shaft 3 is connected to a speed reducer (not shown).

In operation, when the drive shaft 1 is rotated from the lower speed to the higher speed, the roller 13 mounted between the movable pulley 12 and the ramp plate 11 is successively moved outward due to the centrifugal force to force the movable pulley 12 to move on the drive shaft 1 axially toward the drive pulley 14, thereby pressing and expanding the transmission belt 2 mounted between the drive pulley 14 and the movable pulley 12, so that the transmission belt 2 is moved outward from the position as shown in FIG. 1 to the position as shown in FIG. 3. At this time, when the transmission belt 2 mounted between the drive pulley 14 and the movable pulley 12 is moved outward, the transmission belt 2 mounted between the fixed pulley 41 and the movable pulley 51 is forced to contract and is moved inward from the position as shown in FIG. 2 to the position as shown in FIG. 4, to force the movable pulley 51 to move axially far from the fixed pulley 41 to the position as shown in FIG. 4.

On the contrary, when the drive shaft 1 is rotated from the higher speed to the lower speed, the roller 13 mounted between the movable pulley 12 and the ramp plate 11 is successively moved inward due to reduction of the centrifugal force, and the movable pulley 12 is moved axially close toward the ramp plate 11, thereby releasing the transmission belt 2 mounted between the drive pulley 14 and the movable pulley 12, so that the transmission belt 2 is moved inward the drive shaft 1, from the position as shown in FIG. 3 to the position as shown in FIG. 1. At this time, when the transmission belt 2 mounted between the drive pulley 14 and the movable pulley 12 is moved inward, the transmission belt 2 mounted between the fixed pulley 41 and the movable pulley 51 is released to expand and is moved outward from the position as shown in FIG. 4 to the position as shown in FIG. 2, and the movable pulley 51 is moved axially close to the fixed pulley 41 to the position as shown in FIG. 2.

In such a manner, by transmithing of the transmission belt 2, the drive shaft 1 drives the driven shaft 3 to rotate successively, thereby changing the speed of the wheeled vehicle in an infinitely and continuously variable manner.

However, the drive shaft 1 produces a greater power to move the wheeled vehicle, so that when the wheeled vehicle is suddenly braked under the emergency condition or when the rear tires of the wheeled vehicle stop rotation due to touching larger obstacles or obstructions, the power of the drive shaft 1 produces a greater torque to the parts of the conventional CVT and Reducing speed system, so that the parts of the conventional CVT and Reducing speed system are easily broken or worn out during a long-term utilization due to the excessive torque, thereby decreasing the lifetime of the conventional CVT and Reducing speed system. In addition, when the transmission system are locked due to the above-mentioned conditions, the wheeled vehicle is inoperative, thereby causing danger to the driver.

### SUMMARY OF THE INVENTION

The primary objective of the present invention is to provide a torque limiting device for a wheeled vehicle, wherein the torque limiting device is mounted on the shaft end of the driven shaft of the CVT system of the wheeled vehicle, so that when the wheeled vehicle is suddenly braked under the emergency condition or when the rear tires of the wheeled vehicle are subjected to a larger resistance and excessive torque, the driven shaft will disengage from the fixed boss, and rotation of the fixed boss cannot drive and rotate the driven shaft, so that the driven shaft stops rotating temporarily, thereby preventing the transmission parts of the CVT system of the wheeled vehicle from being broken or worn out by the excessive torque.

Another objective of the present invention is to provide a torque limiting device for a wheeled vehicle, wherein the power transmission of the CVT system of the wheeled vehicle is stopped temporarily, thereby preventing the driver from bumping forward due to the resistance or the excessive torque, so as to protect the driver's safety.

In accordance with the present invention, there is provided a torque limiting device for a wheeled vehicle, comprising a fixed boss, a plurality of rolling balls, a roller retainer, a roller seat, at least one disk spring, and a driven housing, wherein:

the fixed boss has a boss end provided with an annular mounting face, the mounting face of the fixed boss is formed with a plurality of positioning recesses;

each of the rolling balls is positioned in a respective one of the positioning recesses of the mounting face of the fixed boss to rotate therewith;

the roller retainer is mounted on the boss end of the fixed boss and has a first side rested on the mounting face of the fixed boss' the roller retainer is formed with a plurality of circular reciving holes to retain the rolling balls, the roller retainer is rotated by the rolling balls;

the roller seat is mounted on the boss end of the fixed boss and has a first side rested on a second side of the roller retainer;

the disk spring is mounted on the boss end of the fixed boss and has a first side rested on a second side of the roller seat; and

the driven housing is secured on a boss end of the driven boss for rotating the driven shaft and is engaged with and rotated by the roller retainer.

Further benefits and advantages of the present invention will become apparent after a careful reading of the detailed description with appropriate reference to the accompanying drawings.

### BRIEF DESCRIPTION OF THE DRAWINGS

FIG. 1 is a schematic plan view of a conventional CVT for a wheeled vehicle in accordance with the prior art;

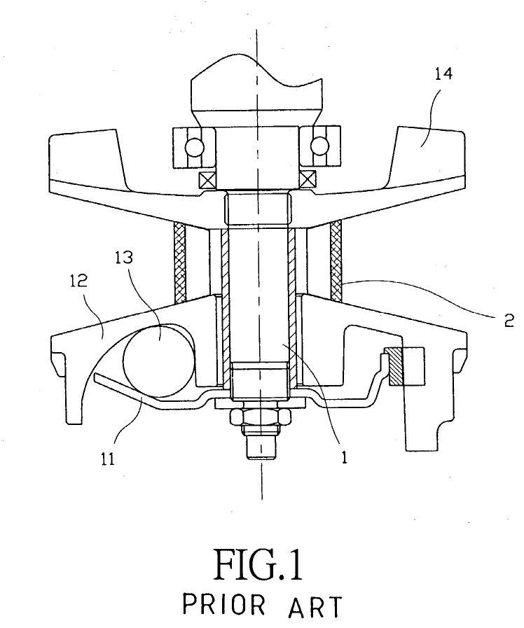

FIG. 2 is a schematic plan cross-sectional view of the conventional CVT for a wheeled vehicle in accordance with the prior art;

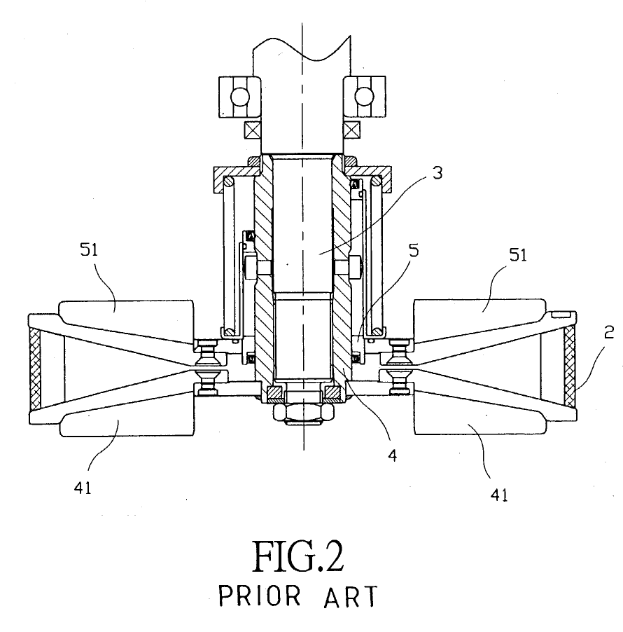

FIG. 3 is a schematic operational view of the conventional CVT as shown in FIG. 1;

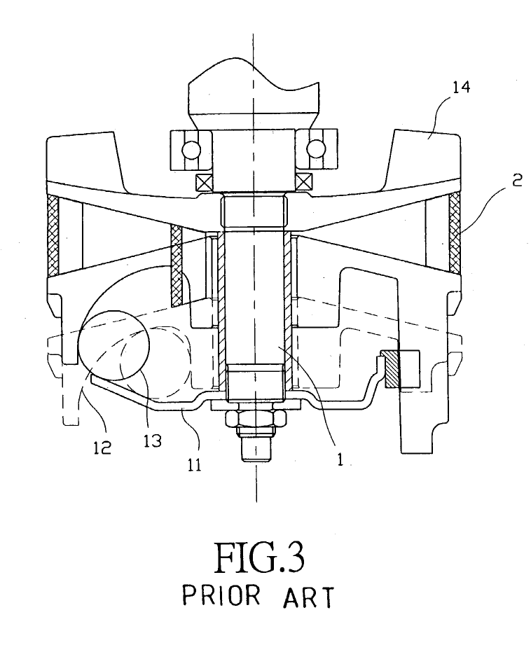

FIG. 4 is a schematic operational view of the conventional CVT as shown in FIG. 2;

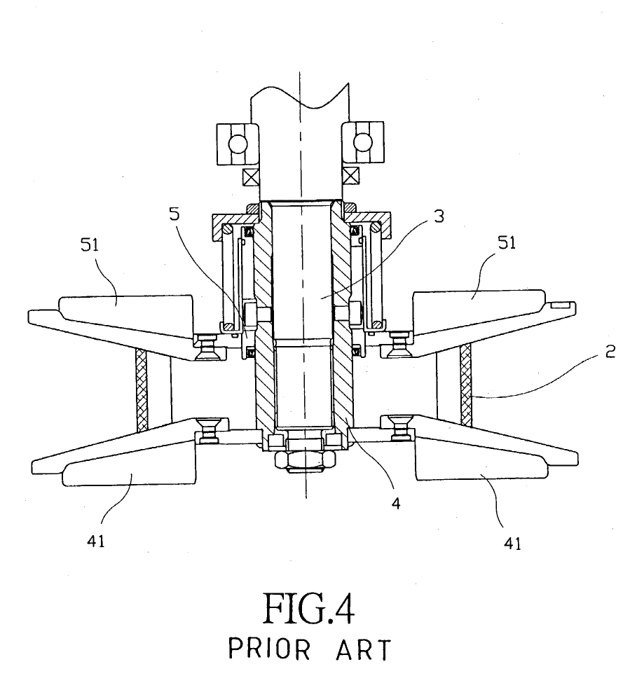

FIG. 5 is an exploded perspective view of the torque limiting device for a wheeled vehicle in accordance with the preferred embodiment of the present invention;

FIG. 6 is a schematic plan view of the front portion of CVT for a wheeled vehicle in accordance with the preferred embodiment of the present invention;

FIG. 7 is a plan cross-sectional assembly view of the torque limiting device which is equipped with the rear portion of CVT for a wheeled vehicle as shown in FIG. 5 which is at under torque situation; and

FIG. 8 is a schematic operational view of the torque limiting device for a wheeled vehicle as shown in FIG. 7 which is at over torque situation.

### DETAILED DESCRIPTION OF THE INVENTION

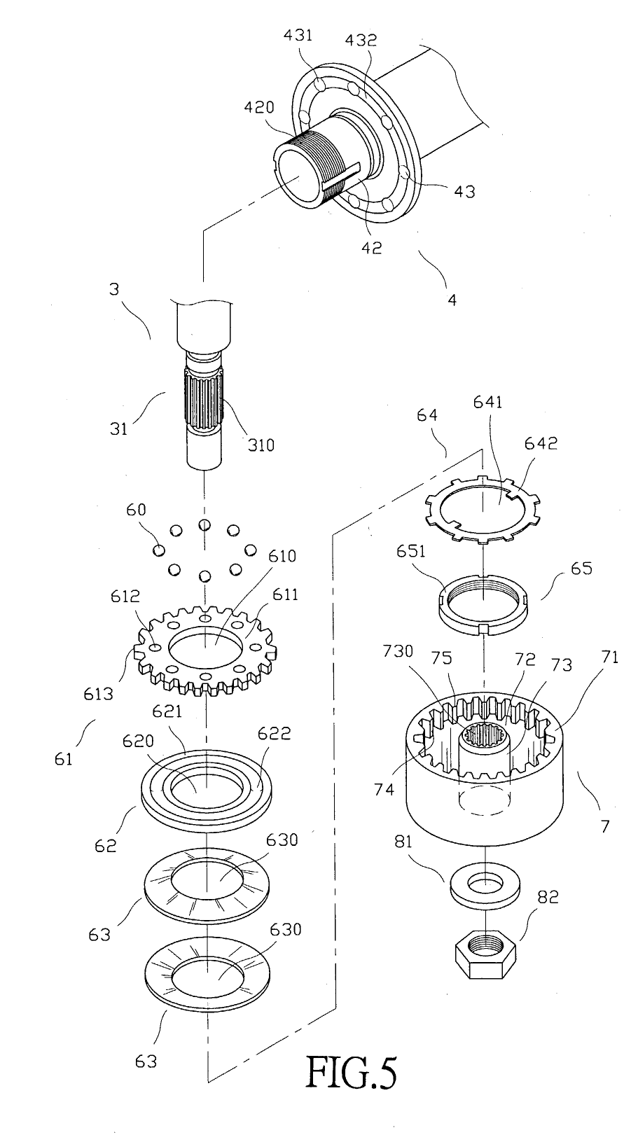

Referring to the drawings and initially to FIGS. 5-7, a torque limiting device for a wheeled vehicle in accordance with the preferred embodiment of the present invention is mounted on the boss end 42 of the fixed boss 4 of the rear portion of CVT (continuously variable transmission).

The torque limiting device comprises a fixed boss 4, a plurality of rolling balls 60, a roller retainer 61, a roller seat 62, at least one disk spring 63, a locking nut 65, a fixing washer 64, and a driven housing 7.

The fixed boss 4 is mounted on the driven shaft 3 for rotating the driven shaft 3. The fixed boss 4 has a boss end 42 provided with an annular mounting face 43. The mounting face 43 of the fixed boss 4 is formed with a plurality of equally spaced circular positioning recesses 431 and an annular groove 432 communicating with each of the positioning recesses 431. The boss end 42 of the fixed boss 4 is formed with an external thread 420.

Each of the rolling balls 60 is positioned in a respective one of the positioning recesses 431 of the mounting face 43 of the fixed boss 4.

The roller retainer 61 is mounted on the boss end 42 of the fixed boss 4. The roller retainer 61 is formed with a plurality of circular receiving holes 612, and each of the rolling balls 60 is received in a respective one of the receiving holes 612 of the roller retainer 61. The roller retainer 61 has an annular plate face 611 rested on the mounting face 43 of the fixed boss 4. The roller retainer 61 has an inner wall formed with a central hole 610 to receive the boss end 42 of the fixed shaft boss 4. The roller retainer 61 has an outer wall formed with a plurality of drive teeth 613.

The roller seat 62 is mounted on the boss end 42 of the fixed boss shaft 4 and has a first side rested on a second side of the roller retainer 61. The roller seat 62 has an inner wall formed with a central hole 620 to receive the boss end 42 of the fixed boss 4. The first side of the roller seat 62 has an annular face 621 formed with an annular guide groove 622 aligning with the receiving holes 612 of the roller retainer 61 to receive and guide the rolling balls 60.

The disk spring 63 is mounted on the boss end 42 of the fixed boss 4 and has a first side rested on a second side the roller seat 62. The disk spring 63 has an inner wall formed with a central hole 630 to receive the boss end 42 of the fixed boss 4.

The locking nut 65 is screwed on the external thread 420 of the boss end 42 of the fixed boss 4 and is rested on a second side of the disk spring 63.

The fixing washer 64 is mounted on the boss end 42 of the fixed boss 4 and sandwiched between the disk spring 63 and the locking nut 65. The fixing washer 64 has an inner wall formed with a central hole 641 to receive the boss end 42 of the fixed boss 4, and formed with several radially wings 642 which are bent to clamp a peripheral groove 651 of the locking nut 65 as assembling to prevent the locking nut 65 from being loosened.

The driven housing 7 is secured on the shaft end 31 of the driven shaft 3 for rotating the driven shaft 3 and is engaged with and rotated by the roller retainer 61. The shaft end 31 of the driven shaft 3 has an outer wall formed with a plurality of engaging teeth 310, and the driven housing 7 has a center formed with a middle cylinder 73 having an inner wall formed with a plurality of engaging teeth 730 meshing with the engaging teeth 310 of the driven shaft 3, so that the driven housing 7 can drive the driven shaft 3 to rotate. The driven housing 7 has an inside formed with a receiving chamber 72. The receiving chamber 72 of the driven housing 7 has a cylindrical wall 74 formed with a plurality of driven teeth 75 meshing with the drive teeth 613 of the roller retainer 61, so that the roller retainer 61 can drive the driven housing 7 to rotate. The cylindrical wall 74 of the driven housing 7 has a top face 71 rested on the mounting face 43 of the fixed boss 4.

The torque limiting device further comprises a locking nut 82 screwed on the shaft end 31 of the driven shaft 3 and rested on a bottom face of the driven housing 7 to secure the driven housing 7 on the driven shaft 3. The torque limiting device further comprises a washer 81 mounted on the shaft end 31 of the driven shaft 3 and sandwiched between the locking nut 82 and the bottom face of the driven housing 7.

In assembly, the rolling balls 60 are sealed in the positioning recesses 431 of the mounting face 43 of the fixed boss 4 by the roller retainer 61 and the roller seat 62 which are pressed by the disk spring 63. In addition, the roller retainer 61, the roller seat 62 and the disk spring 63 are retained on the boss end 42 of the fixed boss 4 by the fixing washer 64 and the locking nut 65. These parts are assembled with the driven fixed boss and then be assembled into rear CVT in one unit. Then it have to assemble this rear CVT unit into wheeled vehicle by inserting the driven housing 7 to connect between driven shaft 3 and rear CVT unit, and locking with washer 81 and nut 82. Then, the driven housing 7 is engaged with the shaft end 31 of the driven shaft 3 and is engaged with the roller retainer 61. In such a manner, the engaging teeth 730 of the middle cylinder 73 of the driven housing 7 mesh with the engaging teeth 310 of the driven shaft 3, so that the driven housing 7 can drive the driven shaft 3 to rotate, while the driven teeth 75 of the cylindrical wall 74 of the driven housing 7 mesh with the drive teeth 613 of the roller retainer 61, so that the roller retainer 61 can drive the driven housing 7 to rotate. Finally, the washer 81 is mounted on the shaft end 31 of the driven shaft 3 and the locking nut 82 is screwed on the shaft end 31 of the driven shaft 3 and rested on the bottom face of the driven housing 7 to secure the driven housing 7 on the driven shaft 3, thereby assembling the torque limiting device for a wheeled vehicle in accordance with the preferred embodiment of the present invention.

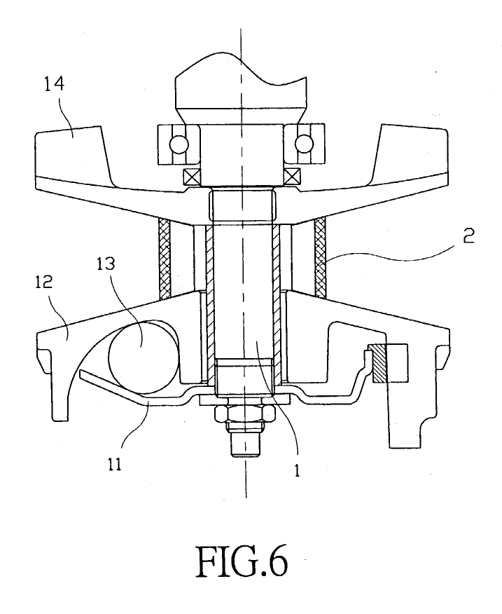

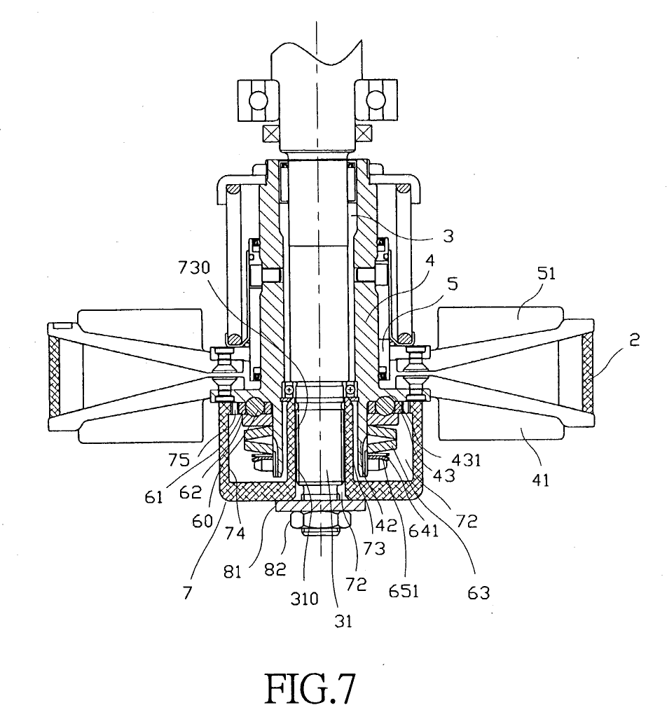

In operation, as shown in FIGS. 6 and 7, by transmitting of the transmission belt 2, the drive shaft 1 can drive and rotate the fixed boss 4 successively to rotate the mounting face 43 of the fixed boss 4. In such a manner, rotation of the mounting face 43 of the fixed boss 4 drives and rotates the rolling balls 60 which rotate the roller retainer 61 which rotates the driven housing 7 which rotates the driven shaft 3 which is connected to a speed reducer (not shown) to change the rotational speed and to transmit the operation power of the wheeled vehicle so as to move the wheeled vehicle. Thus, the drive shaft 1 drives the driven shaft 3 to rotate successively, thereby changing the speed of the wheeled vehicle in a continuously variable manner.

When the rotational speed is at the normal state, the rolling balls 60 mounted on the roller retainer 61 and the roller seat 62 are positioned in the positioning recesses 431 of the mounting face 43 of the fixed boss 4 by the pressing force of the disk spring 63, so that rotation of the fixed boss 4 can drive and rotate the driven housing 7 and the driven shaft 3.

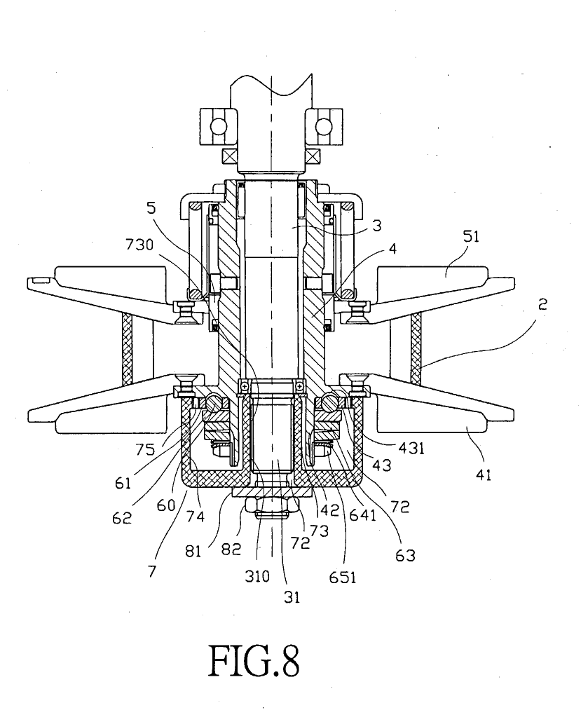

When the wheeled vehicle is suddenly braked under the emergency condition or when the rear tires of the wheeled vehicle are subjected to a larger resistance and the driven shaft have to resist large torque which exceeds the preset torque, the driven shaft 3 is subjected to a reaction (produced by the excessive torque) which is in turn transmitted through the driven housing 7 and the roller retainer 61 to the rolling balls 60, so that the rolling balls 60 are forced to overcome the pressing force of the disk spring 63, thereby detaching the rolling balls 60 from the positioning recesses 431 of the mounting face 43 of the fixed boss 4 as shown in FIG. 8. Thus, the fixed boss 4 will idle, and rotation of the fixed boss 4 cannot drive and rotate the driven housing 7 and the driven shaft 3 in a moment, such that the driven shaft 3 stops rotating, thereby preventing the transmission parts of the CVT and reducing speed system of the wheeled vehicle from being broken or worn out by the excessive torque.

After the excessive torque is removed, the rolling balls 60 are forced to the original position by the restoring force of the disk spring 63, so that the rolling balls 60 are positioned in the positioning recesses 431 of the mounting face 43 of the fixed boss 4 as shown in FIG. 7. Thus, rotation of the fixed boss 4 can again drive and rotate the driven housing 7 and the driven shaft 3.

Accordingly, the rolling balls 60, the roller retainer 61, the roller seat 62 and the disk spring 63 co-operate with each other, so that when the driven shaft 3 is subjected to an excessive torque, the driven housing 7 and the driven shaft 3 will disengage from the fixed boss 4, and rotation of the fixed boss 4 cannot drive and rotate the driven housing 7 and the driven shaft 3, so that the driven shaft 3 stops rotating temporarily, thereby preventing the transmission parts of the CVT and reducing speed system of the wheeled vehicle from being broken or worn out by the excessive torque. In addition, power transmission of the CVT system of the wheeled vehicle is stopped temporarily, thereby preventing the driver from jumping forward due to the resistance or the excessive torque, so as to protect the driver's safety.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A torque limiting device for a wheeled vehicle, comprising a fixed boss, a plurality of rolling balls, a roller retainer, a roller seat, at least one disk spring, and a driven housing, wherein:
the fixed boss has a boss end provided with an annular mounting face, the mounting face of the fixed boss is formed with a plurality of positioning recesses;
each of the rolling balls is positioned in a respective one of the positioning recesses of the mounting face of the fixed boss to rotate therewith;
the roller retainer is mounted on the boss end of the fixed boss and has a first side rested on the mounting face of the fixed boss, the roller retainer is rotated by the rolling balls;
the roller seat is mounted on the boss end of the fixed boss and has a first side rested on a second side of the roller retainer;
the disk spring is mounted on the boss end of the fixed boss and has a first side rested on a second side of the roller seat; and
the driven housing is secured on a boss end of a driven boss for rotating the driven shaft and is engaged with and rotated by the roller retainer.

2. The torque limiting device for a wheeled vehicle in accordance with claim 1, wherein the mounting face of the fixed boss is formed with an annular groove communicating with each of the positioning recesses.

3. The torque limiting device for a wheeled vehicle in accordance with claim 1, wherein the boss end of the fixed boss is formed with an external thread, and the torque limiting device further comprises a locking nut screwed on the external thread of the boss end of the fixed boss and rested on a second side of the disk spring for retaining the roller retainer, the roller seat and the disk spring on the boss end of the fixed boss.

4. The torque limiting device for a wheeled vehicle in accordance with claim 3, further comprising a fixing washer mounted on the boss end of the fixed boss and sandwiched between the disk spring and the locking nut.

5. The torque limiting device for a wheeled vehicle in accordance with claim 4, wherein the fixing washer has an inner wall formed with several radially wings which can be bent to clamp a peripheral groove of the locking nut to prevent the locking nut from being loosened.

6. The torque limiting device for a wheeled vehicle in accordance with claim 1, wherein the roller retainer is formed with a plurality of circular receiving holes, and each of the rolling balls is received in a respective one of the receiving holes of the roller retainer.

7. The torque limiting device for a wheeled vehicle in accordance with claim 1, wherein the roller retainer has an annular plate face rested on the mounting face of the fixed boss.

8. The torque limiting device for a wheeled vehicle in accordance with claim 6, wherein the first side of the roller seat has an annular face formed with an annular guide groove aligning with the receiving holes of the roller retainer to receive and guide the rolling balls.

9. The torque limiting device for a wheeled vehicle in accordance with claim 1, wherein the boss end of the driven boss has an outer wall formed with a plurality of engaging teeth, and the driven housing has a center formed with a middle cylinder having an inner wall formed with a plurality of engaging teeth meshing with the engaging teeth of the driven shaft, so that the driven housing can drive the driven shaft to rotate.

10. The torque limiting device for a wheeled vehicle in accordance with claim 1, wherein the roller retainer has an outer wall formed with a plurality of drive teeth, and the driven housing has an inside formed with a receiving chamber, the receiving chamber of the driven housing has a cylindrical wall formed with a plurality of driven teeth meshing with the drive teeth of the roller retainer, so that the roller retainer can drive the driven housing to rotate.

11. The torque limiting device for a wheeled vehicle in accordance with claim 10, wherein the cylindrical wall of the driven housing has a top face rested on the mounting face of the fixed boss.

12. The torque limiting device for a wheeled vehicle in accordance with claim 1, further comprising a locking nut screwed on the shaft end of the driven shaft and rested on a bottom face of the driven housing to secure the driven housing on the driven shaft.

13. The torque limiting device for a wheeled vehicle in accordance with claim 12, further comprising a washer mounted on the shaft end of the driven shaft and sandwiched between the locking nut and the bottom face of the driven housing.

14. The torque limiting device for a wheeled vehicle in accordance with claim 1, wherein the rolling balls are positioned in the positioning recesses of the mounting face of the fixed boss by the roller retainer and the roller seat which are pressed by the disk spring.
